(19) United States
(12) Patent Application Publication
(10) Pub. No.: US 2018/0142734 A1
(43) Pub. Date: May 24, 2018

(54) SPHERICAL STEEL BEARING, INTELLIGENT BEARING AND BEARING MONITORING SYSTEM

(71) Applicants: Shenzhen Municipal Design & Research Institute Co., Ltd., Shenzhen City (CN); Shenzhen Innova-Wise Engineering Technology, Shenzhen City (CN)

(72) Inventors: Weiming GAI, Shenzhen City (CN); Ruijuan JIANG, Shenzhen City (CN); Fang YU, Shenzhen City (CN); Yiyan CHEN, Shenzhen City (CN); Jie PENG, Shenzhen City (CN); Jucan DONG, Shenzhen City (CN)

(73) Assignees: Shenzhen Municipal Design & Research Institute Co., Ltd., Shenzhen (CN); Shenzhen Innova-Wise Engineering Technology Consulting Co., Ltd., Shenzhen City (CN)

(21) Appl. No.: 15/865,191

(22) Filed: Jan. 8, 2018

Related U.S. Application Data
(63) Continuation of application No. PCT/CN2016/097573, filed on Aug. 31, 2016.

(30) Foreign Application Priority Data
Jul. 18, 2016 (CN) 201610567009X

(51) Int. Cl. F16C 41/00; F16C 33/32; G01L 5/00

(52) U.S. Cl. CPC F16C 41/007; F16C 2233/00; G01L 5/0009; F16C 33/32

(57) ABSTRACT

Disclosed are a spherical steel bearing, an intelligent bearing and a bearing monitoring system, belonging to the technical field of bearings. The spherical steel bearing comprises a top bearing plate, a bottom bearing plate, a spherical steel plate and a base plate, wherein the base plate are stacked together with the top bearing plate or the bottom bearing plate. A pressure sensing unit is arranged between the top bearing plate and the base plate or between the bottom bearing plate and the base plate. The intelligent bearing includes a data acquisition unit, a data output unit and the spherical steel bearing, the data acquisition unit transmitting the bearing pressure measured by the pressure sensing unit to the data output unit. The bearing monitoring system includes a data acquisition unit, a data output unit, a monitoring center and the spherical steel bearing.

This application is a Continuation of PCT Application No. PCT/CN2016/097573, filed Aug. 31, 2016, which is hereby incorporated by reference.

### TECHNICAL FIELD

The present disclosure relates to the technical field of bearings, in particular to a spherical steel bearing, an intelligent bearing and a bearing monitoring system.

### BACKGROUND

Spherical steel bearings have been widely used in actual bridge engineering in many countries around the world due to the large bearing capacity and relatively mature technology. The spherical steel bearing is a bearing frequently-used in bridges, which has wide applications and features reliable transmission of force, flexible rotation and better adaptability to the needs of bearings for large rotation angles. The spherical steel bearing transmits force through its spherical surface, so that necking will not occur. Rotation of the bearing is realized through sliding of a PTFE plate on the spherical surface with a small rotating torque. The rotating torque is solely related to the spherical radius and the friction coefficient of the PTFE plate, not the rotation angle of the bearing, and the bearing has consistent rotating performance in all directions. The bearing does not use rubber for pressure bearing, so that the rotation performance of the bearing will not be affected due to aging of the rubber, thus the spherical steel bearing is particularly useful in low temperature regions. When a bridge structure rotates by an angle, a spherical steel plate rotates to release the torque generated at an upper structure of the bridge. Thus, not only can a reasonable relative displacement between the upper and lower structures of the bridge be ensured, but a uniform bridge structure can be maintained. Such bearings are suitable for long-span spatial structures and long-span bridges, especially wide bridges, curved bridges and skew bridges.

In a bridge structure, the stability and reliability of the bearing which serves as a main force transfer component directly affects the safety performance of the entire bridge. Bearing failure will lead to the overall collapse of the entire bridge, resulting in immeasurable serious consequences, and therefore the long-term safety of the bearing is particularly important. For the spherical steel bearing, metal components are subjected to fatigue over time. For different operating environments, the durability of the bearing and whether bearing failure occurs due to the influence of various factors such as metal loss, fatigue, etc., are all related to the overall safety of the bridge. From the long-term health situation of the bridge, it is particularly important to monitor the health status of an isolation bearing.

In the prior art, the monitoring of the force condition for the isolation bearing mainly relies on the pressure sensing unit, and the pressure data information which is measured by the sensing unit needs to be exported by a lead wire. Thus, there is a need to make micro-holes on the bearing to lead out the lead wire, thus causing the overall mechanical properties of the bearing to be affected. As the bridge bearing needs to bear a huge load, even tiny pores will cause huge safety risks. In addition, the replacement of the sensor unit is also a problem faced by the current bearing technology. Since the sensing unit is usually fixedly connected to the bearing body or embedded in the bearing, if the sensor unit is replaced, the entire bearing needs to be replaced, leading to a high cost and complicated operation.

### SUMMARY OF THE INVENTION

The technical problem to be solved by the disclosure is to provide a spherical steel bearing which is capable of monitoring the force condition of the bearing in real time, has no influence on mechanical properties of the bearing and facilitates replacement of the pressure sensing unit.

The further technical problem to be solved by the disclosure is to provide an intelligent bearing and a bearing monitoring system which can monitor and reflect the health status of the bearing in real time.

The technical solution that the disclosure adopts to solve the above technical problems is as follows.

It provides that a spherical steel bearing comprising a top bearing plate, a bottom bearing plate and a spherical steel plate arranged between the top bearing plate and bottom bearing plate. The spherical steel bearing further comprises a base plate stacked together with the top bearing plate or bottom bearing plate, wherein a pressure sensing unit is arranged between the top bearing plate and the base plate, or between the bottom bearing plate and the base plate.

As a further improvement of the above technical solution, the pressure sensing unit is a nano-rubber sensor.

As a further improvement of the above technical solution, the base plate and the nano-rubber sensor are arranged between the top bearing plate and the spherical steel plate or below the bottom bearing plate.

As a further improvement of the above technical solution, a nano-rubber sensor array is arranged between the top bearing plate and the base plate, or between the bottom bearing plate and the base plate.

As a further improvement of the above technical solution, the nano-rubber sensor comprises at least two fabric layers, and the adjacent fabric layers are filled with nano-conductive rubber which is a rubber substrate doped into carbon nanotubes.

As a further improvement of the above technical solution, a limit unit is arranged on a lateral side of the base plate which is subjected to a lateral force.

As a further improvement of the above technical solution, the limit unit is a strip-shaped steel bar or limit block, and is fixedly connected to the top bearing plate or the bottom bearing plate by bolts and abuts against the lateral side of the base plate.

The disclosure provides an intelligent bearing, comprising a data acquisition unit, a data output unit, and the spherical steel bearing as described above, wherein the data acquisition unit transmits bearing pressure data measured by the pressure sensing unit to the data output unit.

The disclosure further provides a bearing monitoring system, comprising a data acquisition unit, a data output unit, a monitoring center and the spherical steel bearing as described above. The data acquisition unit transmits bearing pressure data measured by the pressure sensing unit to the data output unit, and the data output unit transmits the pressure data to the monitoring center.

As a further improvement of the above technical solution, the monitoring center comprises a data receiving unit, a server, a monitoring unit, an analysis unit, and a human-computer interaction unit. The data receiving unit transmits the pressure data of the data output unit to the server, the monitoring unit, the analysis unit and the human-computer interaction unit.

The disclosure has the beneficial effects that:

1. The pressure sensing unit is arranged between the top bearing plate and the base plate, or between the bottom bearing plate and the base plate, and is therefore easy to replace, and a real-time monitoring of the force state for the bearing can be realized.

2. The lead wire of the pressure sensing unit is led out from between the top bearing plate and the base plate, or from between the bottom bearing plate and the base plate, thus there is no need to make micro-holes for the lead wire on the bearing, ensuring that the mechanical properties of the bearing are not affected.

3. The bearing monitoring system of the disclosure can instantaneously transmit the pressure data measured by the pressure sensing unit to the monitoring center which then monitors and analyzes the pressure data so as to monitor and reflect the health status of the bearing in real time.

### BRIEF DESCRIPTION OF THE DRAWINGS

FIG. 1A-1B are cross-sectional views of an overall structure of a spherical steel bearing in the 1st embodiment of the disclosure, wherein FIG. 1A shows one sensor, and FIG. 1B shows a plurality of sensors;

FIG. 2 is a cross-sectional view of the overall structure of the spherical steel bearing in the 2nd embodiment of the disclosure;

FIG. 3 is a cross-sectional view of the overall structure of the spherical steel bearing in the 3rd embodiment of the disclosure;

FIG. 4 is a schematic view of an overall structure of a nano-rubber sensor of the spherical steel bearing of the disclosure; and

FIG. 5 is a schematic view showing the connection of modules of a bearing monitoring system of the disclosure.

### DETAILED DESCRIPTION OF THE EMBODIMENTS

In order that the objects, features and effects of the disclosure may be fully understood, a full and clear description of concepts, specific structures and technical effects produced of the disclosure will be made below in connection with embodiments and accompanying drawings. Obviously, the embodiments described are merely a part, but not all embodiments of the disclosure. Based on the embodiments of the disclosure, other embodiments obtained by the skilled in the art without inventive effort should all belong to the protection scope of the disclosure. In addition, all the coupling/connecting relationships mentioned herein do not merely refer to direct connection or coupling of members, but rather a better coupling structures formed by adding or subtracting coupling accessories according to specific implementation. Technical features of the disclosure may be combined as long as they are not mutually contradictory.

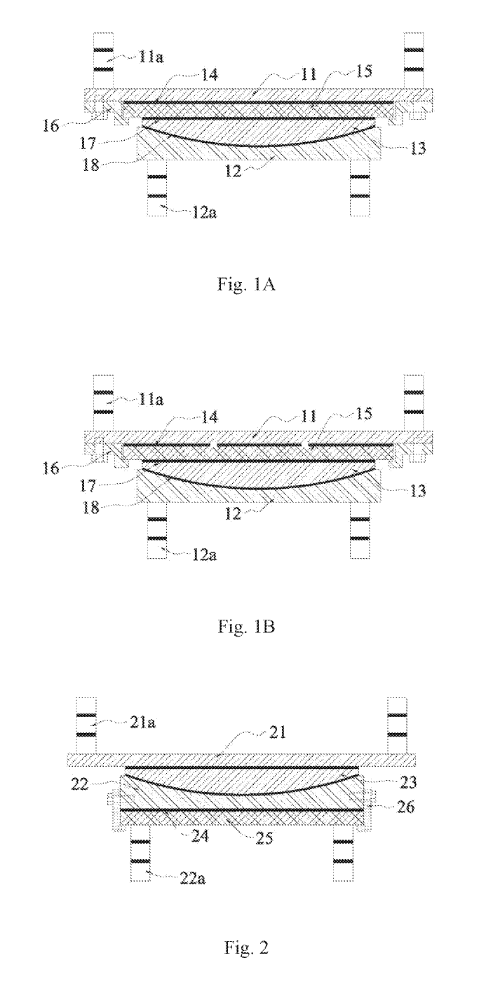

FIG. 1A shows a specific structure of a spherical steel bearing in embodiment 1 of the disclosure. As shown in FIG. 1A, the spherical steel bearing of the disclosure includes a top bearing plate 11, a bottom bearing plate 12, a spherical steel plate 13, a nano-rubber sensor 14, a base plate 15, a limit unit 16, a planar slide plate 17 and a spherical slide plate 18. A top sleeve 11a is fixedly provided on the upper surface of the top bearing plate 11, and a bottom sleeve 12a is fixedly provided on the lower surface of the bottom bearing plate 12a, the top sleeve 11a and the bottom sleeve 12a being used for fixed connection with constructions such as bridges, etc.

The spherical steel plate 13 has a planar upper surface and a convex spherical surface. The bottom bearing plate 12 has a concave spherical surface. The planar slide plate 17 is arranged between the upper surface of the spherical steel plate 13 and the base plate 15, and the spherical slide plate 18 is arranged between the lower surface of the spherical steel plate 13 and the bottom bearing plate 12, the spherical surfaces of the spherical steel plate 13, the spherical slide plate 18 and the bottom bearing plate 12 having the same curvature radius. Both the planar slide plate 17 and the spherical slide plate 18 serve to cause a small sliding between the top bearing plate 11 and the bottom bearing plate 12 so as to release a torque generated by the deflection of the upper structure as well as a horizontal force generated due to the temperature-caused deformation.

Of course in various embodiments, the concave spherical surface may be provided on the spherical steel plate 14, and the convex spherical surface having the same curvature may be provided on the bottom bearing plate 12, as long as a spherical sliding surface can be formed by the bottom bearing plate 12 and the spherical steel plate 14.

Preferably, in this preferred embodiment, both the planar slide plate 17 and the spherical slide plate 18 are made of a low friction material, such as but not limited to PTFE, etc.

The spherical steel bearing adopts the nano-rubber sensor 14 to detect the force condition of the bearing in real time, and then obtains the vertical pressure variation value of the bearing. As the nano-rubber sensor 14 is thin in thickness and simple in structure, it does not affect various mechanical properties of the bearing. As the rubber has good fatigue resistance and high temperature resistance, the nano-rubber sensor 14 has a high durability and a number of alternating stress cycles greater than 50 million.

In preferred embodiments of the disclosure, the nano-rubber sensor 14 is used as a pressure measuring unit. Of course, other pressure sensors can also be used, such as but not limited to, a strain gauge pressure sensor, a ceramic pressure sensor, a diffused silicon pressure sensor, a piezoelectric pressure sensor, etc.

In this preferred embodiment, the base plate 15 and the nano-rubber sensor 14 are arranged between the top bearing plate 11 and the spherical steel plate 13. The limit unit 16 is arranged on a lateral side of the base plate 15 which is subjected to a lateral force, so as to ensure the stability of the base plate 15 under the effect of the lateral force. In various embodiments, the base plate 15 can also be arranged above the top bearing plate 11, so long as the base plate 15 and the top bearing plate 11 are stacked and have the nano-rubber sensor 14 arranged therebetween.

The limit unit 16, which is preferably a strip-shaped steel bar shown in FIG. 1A, is fixedly connected to the top bearing plate 11 by bolts and abuts against the lateral side of base plate 15. Of course, the shape, the fixed position and fixed manner of the limit unit 17 are not limited to the above-described embodiments, as long as the limiting function is achieved. The limit unit 16 and the base plate 15 are connected by bolts to facilitate the replacement of the nano-rubber sensor 14. In case of replacement, the limit unit 16 is taken off first, and then the top bearing plate 11 together with the construction thereabove is jacked using a jacking device, thus the nano-rubber sensor 14 can be replaced.

In order to accurately measure the force condition of the entire bearing and avoid partial load, preferably, an array of the nano-rubber sensors 14 is arranged between the top bearing plate 11 and the base plate 15, as shown in FIG. 1B. High-temperature-resistance shielding lead wires 17 connecting two electrodes of the nano-rubber sensor 14 is led out from a gap between the base plate 15 and the top bearing plate 11, thus there is no need to make micro-holes for the lead wire on the bearing, effectively ensuring the mechanical properties of the bearing.

FIG. 2 shows a specific structure of a spherical steel bearing in embodiment 2 of the disclosure. The difference between this embodiment and embodiment 1 lies in that the nano-rubber sensor 24 and the base plate 25 are stacked below the bottom bearing plate 22.

As shown in FIG. 2, the spherical steel bearing of the disclosure comprises a top bearing plate 21, a bottom bearing plate 22, a spherical steel plate 23, a nano-rubber sensor 24, a base plate 25 and a limit unit 26. The spherical steel plate 23 is arranged between the top bearing plate 21 and the bottom bearing plate 22, the base plate 25 is arranged below the bottom bearing plate 22, and the nano-rubber sensor 24 is placed between the base plate 25 and the bottom bearing plate 22. The limit unit 26 is fixedly connected with the bottom bearing plate 22 by bolts and abuts against a lateral side of the base plate 25. A top sleeve 21a is fixedly provided on the upper surface of the top bearing plate 21, and a bottom sleeve 22a is fixedly provided on the lower surface of the base plate 25.

Similarly, in various embodiments, the base plate 25 can also be arranged between the bottom bearing plate 22 and the spherical steel plate 23, so long as the base plate 25 and the bottom bearing plate 22 are stacked and have the nano-rubber sensor 24 arranged therebetween.

In this embodiment, upon replacing the nano-rubber sensor 24, the limit unit 26 is taken off first, and then the top bearing plate 21, the construction above the top bearing plate 21, the spherical steel plate 23 and the bottom bearing plate 22 are simultaneously jacked up to allow replacement of the nano-rubber sensor 24. Since the top bearing plate 21 and the spherical steel plate 23, and the spherical steel plate 23 and the bottom hinge 22 are in non-fixed connection, in order to facilitate the overall jacking of the components above, preferably a locking mechanism can be used to lock the above components together as one piece during jacking.

FIG. 3 shows a specific structure of the spherical steel bearing in embodiment 3 of the disclosure. The differences between this embodiment and embodiment 1 lie in that not only the base plate 35 is limited by the limit unit 36, but also an extension end 36a of the limit unit 36 provides some cushioning and limiting effect to the bottom bearing plate 32 arranged therebelow. In particular, the extension end 36a of the limit unit 36 sets a range of relative sliding for the top bearing plate 31 and the bottom bearing plate 32, and the extension end 36a is provided with a high-damping rubber strip 36b which can provide a good cushioning and damping effect.

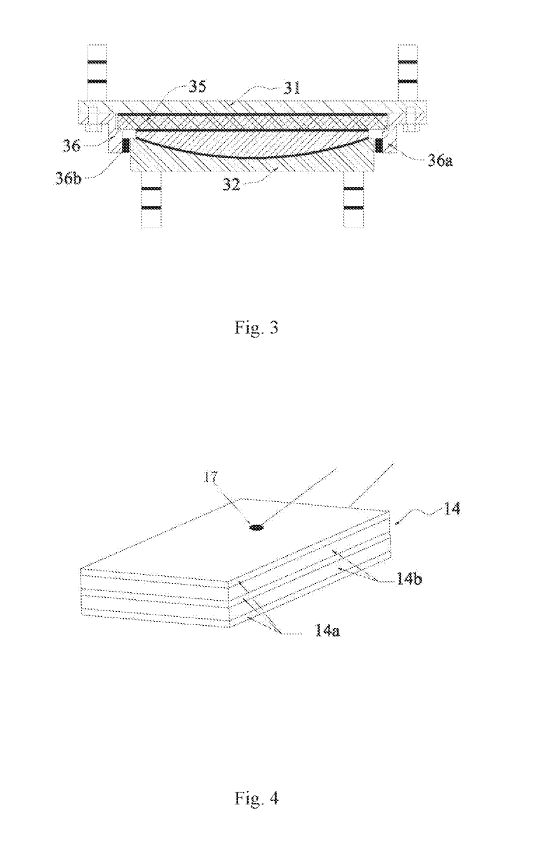

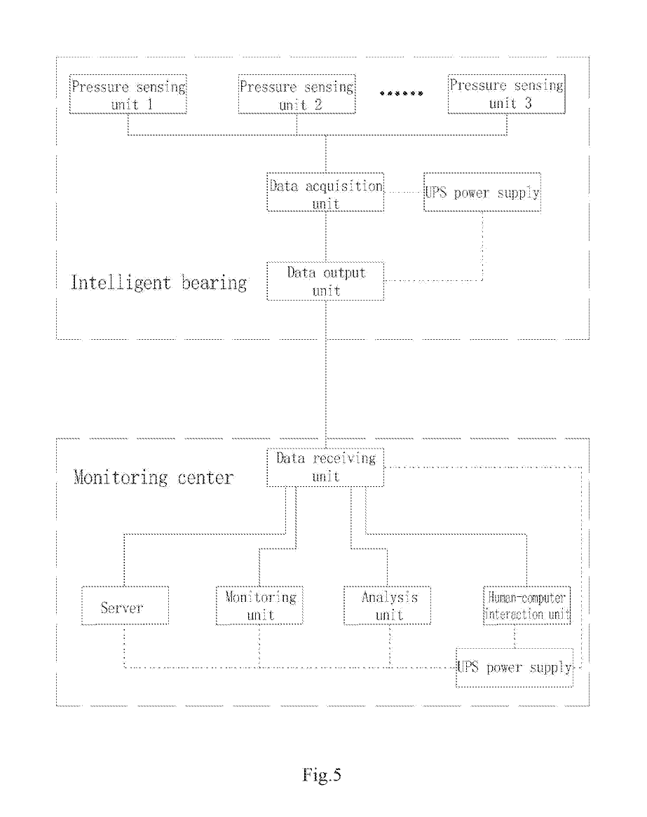

FIG. 4 shows a schematic view of the overall structure of the nano-rubber sensor 14 of the spherical steel bearing of the disclosure.

The operating principle of the nano-rubber sensor is as follows: the nano-rubber sensor is deformed under the action of an external load, so that the distance between conductive particles in the conductive rubber and a conductive network formed by the conductive particles is changed, showing changes in the resistivity and resistance of the conductive rubber, thus causing changes in the measurement of electrical signals. Then, according to the piezoresistive characteristics of the conductive rubber, the force condition of a pressure bearing surface can be obtained by derivation.

Preferably, the nano-rubber sensor 14 is of a multilayer structure, wherein as skeleton layers, a plurality of high strength fabric layers 14a are distributed at intervals from top to bottom, and nano-conductive rubber 14b of a certain thickness is filled between the fabric layers 14a. The fabric layers 14a are dense in texture, and have a certain thickness, elasticity and strength, satisfying the requirement of elastic deformation under a high pressure without damage. Preferably, the fabric layers 14a are made of elastic fibers such as medium or high spandex, high elastic nylon, etc. At the same time, there are gaps in the texture formed by the vertical and horizontal fibers of the fabric layers 14a, which ensure that a nano-conductive rubber solution covered on the fabric layers 14a can penetrate into the gaps during preparation, enhancing the integrity of the structure. The rubber substrate material of the nano-conductive rubber 14a is polydimethylsiloxane rubber (PDMS) consisting of basic constituents and a curing agent in a mixing ratio of 10:1; conductive fillers are carbon nanotubes, preferably multi-walled carbon nanotubes (MWCNT). The mass percentage of the multi-walled carbon nanotubes is between 8% and 9%.

The high strength fabric layers 14a are added to the nano-rubber sensor 14 as a stiff skeleton, which significantly improves the strength and toughness of the nano-rubber sensor 14 under a high pressure of 0 to 50 MPa, avoiding tearing and ensuring the stability and repeatability of such sensing unit under high pressure.

The preparation of nano-rubber sensor is carried out mainly by solution blending and molding. The specific preparation method comprises the following steps:

S1, ingredient mixing: weighing the basic constituents of polydimethylsiloxane rubber (PDMS), the curing agent and carbon nanotubes in accordance with a mass ratio, pouring the mixture into a mixer, and grinding and mixing the same mechanically at room temperature to ensure that the carbon nanotubes are uniformly distributed in the rubber substrate to make the nano-conductive rubber solution.

S2, synthesis: preparing a plurality of high-strength fabrics of the same size, laying a fabric layer on a bottom plate of a mold, uniformly coating the nano-conductive rubber solution prepared in S1 onto the fabric at a certain thickness, and then laying another fabric layer on the same, wherein depending on the thickness demand of nano-conductive rubber sensing elements, the process of coating the nano-conductive rubber solution and additionally laying the fabric layer can be repeated.

S3, curing: placing a top plate of the mold on the uppermost fabric layer of the uncured nano-rubber sensor; through the connection between the upper, lower, top and bottom plates of the mold, applying a certain pressure to the nano-conductive rubber material to ensure uniformity and compactness of the thickness thereof; and placing the mold in a container at 60° C., vacuuming the container and leaving it for at least 300 min.

After the nano-rubber sensor is cured, the cured sheet type nano-rubber sensor can be cut into the desired sizes and shapes by machining tools according to design requirements of the sensor. After connecting the electrode and the insulating protective layer, a sheet-type flexible nano-conductive rubber pressure sensor having a large measuring range is fabricated.

FIG. 5 is a schematic view showing the connection of modules of a bearing monitoring system of the disclosure. The bearing monitoring system of the disclosure includes an intelligent bearing and a monitoring center.

The intelligent bearing comprises the spherical steel bearing as described above, a data acquisition unit, a data output unit, and a UPS power supply. The data acquisition unit acquires pressure data of each of the nano-rubber sensors in the spherical steel bearing. The data output unit is preferably an optical wireless switch, which transmits the pressure data to the monitoring center. The UPS provides uninterrupted power to the electricity-consuming modules in the intelligent bearing.

The monitoring center comprises a data receiving unit, a server, a monitoring unit, an analysis unit, a human-computer interaction unit and a UPS power supply. The data receiving unit is also preferably an optical wireless switch, which is used to receive the pressure data transmitted by the data output unit. The data receiving unit transmits the received data to the server, the monitoring unit, the analysis unit and the human-computer interaction unit, the server manages and controls the data, the monitoring unit performs instant monitoring on the data, and the analysis unit evaluates and analyzes the data. The UPS power supply provides uninterrupted power to the electricity-consuming modules in the monitoring center.

Through the acquisition, transmission, monitoring and analysis performed on the monitoring data of the bearing, the bearing monitoring system can instantly understand and judge the health status of the bearing to ensure the safe use of the bearing.

Preferred embodiments of the disclosure have been described above, but the disclosure is not limited thereto. Numerous variations, substitutions and equivalents may be made by those skilled in the art without departing from the spirit of the disclosure and should all fall within the scope defined by the claims of the application.

1. A spherical steel bearing, comprising a top bearing plate, a bottom bearing plate and a spherical steel plate arranged between the bottom bearing plate and the bottom bearing plate, and characterized by further comprising a base plate stacked together with the top bearing plate or the bottom bearing plate, wherein at least one pressure sensing unit is arranged between the top bearing plate and the base plate, or between the bottom bearing plate and the base plate.

2. The spherical steel bearing according to claim 1, wherein the pressure sensing unit is a nano-rubber sensor.

3. The spherical steel bearing according to claim 2, wherein the base plate and the nano-rubber sensor are arranged between the top bearing plate and the spherical steel plate or below the bottom bearing plate.

4. The spherical steel bearing according to claim 2, wherein an array of the nano-rubber sensors are arranged between the top bearing plate and the base plate, or between the bottom bearing plate and the base plate.

5. The spherical steel bearing according to claim 2, wherein the nano-rubber sensor comprises at least two fabric layers, and the adjacent fabric layers are filled with nano-conductive rubber which is a rubber substrate doped into carbon nanotubes.

6. The spherical steel bearing according to claim 1, wherein a limit unit is arranged on a lateral side of the base plate which is subjected to a lateral force.

7. The spherical steel bearing according to claim 6, wherein the limit unit is a strip-shaped steel bar or limit block, and is fixedly connected to the top bearing plate or the bottom bearing plate by bolts and abuts against the lateral side of the base plate.

8. An intelligent bearing, characterized by comprising: a data acquisition unit, a data output unit, and the spherical steel bearing according to claim 1, wherein the data acquisition unit transmits bearing pressure data measured by the pressure sensing unit to the data output unit.

9. A bearing monitoring system, characterized by comprising: a data acquisition unit, a data output unit, a monitoring center and the spherical steel bearing according to claim 1, wherein the data acquisition unit transmits the bearing pressure data measured by the pressure sensing unit to the data output unit, and the data output unit transmits the pressure data to the monitoring center.

10. The bearing monitoring system according to claim 9, wherein the monitoring center includes a data receiving unit, a server, a monitoring unit, an analysis unit and a human-computer interaction unit, wherein the data receiving unit transmits the pressure data of the data output unit to the server, the monitoring unit, the analysis unit and the human-computer interaction unit.
